(19) United States
(12) Patent Application Publication
(10) Pub. No.: US 2026/0093735 A1
(43) Pub. Date: Apr. 2, 2026

(54) COMPUTING CONFIDENCE SCORES FOR LARGE LANGUAGE MODEL-BASED RETRIEVAL AUGMENTATION TOOLS

(71) Applicant: GM Global Technology Operations LLC, Detroit, MI (US)

(72) Inventors: Arun Adiththan, Sterling Heights, MI (US); Ramesh Sethu, Troy, MI (US); Prakash M. Peranandam, Rochester Hills, MI (US); Azeem Sarwar, Rochester Hills, MI (US); Howard J. Carver, Milford, MI (US); Eshan Dixit, Farmington Hills, MI (US); Mihir Gupte, Royal Oak, MI (US); Muhammad Tayyab, Troy, MI (US)

(21) Appl. No.: 18/901,107

(22) Filed: Sep. 30, 2024

(51) Int. Cl. G06F 16/33; G06F 40/30

(52) U.S. Cl. CPC G06F 16/3344; G06F 16/3347; G06F 40/30

(57) ABSTRACT

A system for computing confidence scores for large language model (LLM) based retrieval augmentation (RAG) tools includes a host device having a controller. The controller executing programmatic control logic including an algorithm for computing confidence scores for LLM based RAG tools (CLR application). The CLR application receives an input to the LLM from a user and engages an ensemble retriever. The ensemble retriever determines a similarity between the input and predetermined data in the one or more databases. The ensemble retriever generates an output and an output confidence score. The CLR application then causes a human validator to prioritize and review the output in accordance with the output confidence score, where the output is a command to one or more systems of the host device. The system progressively reduces computational resource utilization, progressively increases computational efficiency, and progressively reduces reliance on the human validator over time.

### INTRODUCTION

The present disclosure relates to systems and methods for generating validation test suites for artificial intelligence powered tools, and more specifically to automatic generation of validation and evaluation test suites for large language model powered tools. Artificial intelligence (AI) models, including large language models (LLMs) are increasingly being used to perform tasks for end users in a variety of technical and non technical pursuits. Outputs of AI models, including LLMs, can be hampered by lack of systematic coverage metrics, non-diversified test sets and uneven test coverages and coverage measurements. Accordingly, LLMs are trained on vast quantities of data, often from a variety of sources, and then retrieval-augmented generation (RAG) processes are used to optimize the outputs of the LLMs to ensure accuracy. However, even RAG-assisted LLMs can generate outputs that are less relevant, inaccurate, inappropriate, or otherwise compromised for a variety of reasons.

Accordingly, while current systems and methods for validation of generative AI powered tools achieve their intended purpose, there is a need for a new and improved system and method that provides a systematic approach to automatically determine accuracy, relevancy, and consistency of RAG tool assisted LLMs that ensure LLM output accuracy, precision, consistency, reliability, and which provide redundant and consistent checks to ensure the LLM output accuracy, precision, consistency and reliability are maintained while maintaining or reducing system complexity.

### SUMMARY

According to several aspects of the present disclosure, a system for computing confidence scores for large language model (LLM) based retrieval augmentation (RAG) tools includes a host device having a controller. The controller has a processor, a memory, and input/output (I/O) ports. The I/O ports are in communication with a human-machine interface (HMI) and one or more databases. The processor executing programmatic control logic stored in the memory. The programmatic control logic includes an algorithm for computing confidence scores for LLM based RAG tools (CLR application). The CLR application includes at least a first, a second, a third, and a fourth control logic. The first control logic receives an input to the LLM from a host device user. The second control logic engages an ensemble retriever. The ensemble retriever determines a similarity between the input and predetermined data in the one or more databases stored in the memory. The third control logic causes the ensemble retriever to generate an output and an output confidence score. The fourth control logic causes a human validator to prioritize and review the output in accordance with the output confidence score. The output is a command to one or more systems of the host device. The system progressively reduces computational resource utilization, progressively increases computational efficiency, and progressively reduces reliance on the human validator over time.

In another aspect of the present disclosure the first control logic further includes control logic for receiving the input via the human-machine interface (HMI) of the host device.

In another aspect of the present disclosure the second control logic further includes engaging a semantic tool that extracts semantic information from the input. The semantic tool converts extracted semantic information from the input into a vector in vector space such that the vector defines a mathematical, graphical, vectorized representation of semantic information within the input.

In another aspect of the present disclosure the semantic tool further includes control logic for accessing a text vector database stored in memory, wherein the text vector database contains a plurality of predefined semantic text vectors defining mathematical, graphical, vectorized representations of predefined semantic inputs that the host device is programmed to accept and respond to; and control logic for comparing predefined semantic text vectors in the text vector database to vectorized extracted semantic information from the input.

In another aspect of the present disclosure the semantic tool further includes control logic for using ranked fusion to calculate a semantic similarity score according to: a retrieved context Cᵢ₁, a vector similarity score, Sᵢ, and eliminating context Cᵢ when a similarity score of Cᵢ is such that the vector similarity score Sᵢ is less than a threshold T. The semantic tool further includes control logic for fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and ranking context based on the importance score ICᵢ according to:

$$Ret \_a = [ ( C\_a1 , S\_a1 ) , ( C\_a2 , S\_a2 ) , … ( {C}_{an} , {S}_{an} ) ]$$

$$Ret \_b = [ ( C\_b1 , S\_b1 ) , ( C\_b2 , S\_b2 ) , … ( {C}_{bn} , {S}_{bn} ) ]$$

$$Ret \_c = [ ( C\_c1 , S\_c1 ) , ( C\_c2 , S\_c2 ) , … ( {C}_{cn} , {S}_{cn} ) ]$$

where, context {Cᵢⱼ}, j≥1 is ranked based on similarity score, i.e.: Sᵢ₁>Sᵢ₂ . . . >Sᵢₙ. “Low quality” contexts have vector similarity scores Sᵢ less than the threshold T, while “high quality” contexts have importance scores ICᵢ indicating that the input is closely related to or directly implicates critical host device functions.

In another aspect of the present disclosure the CLR application further includes control logic for engaging a syntactic tool that extracts syntactic information from the input. The syntactic tool converts extracted syntactic information from the input into an input raw text vector in vector space such that the vector defines a mathematical, graphical, vectorized representation of syntactic information within the input.

In another aspect of the present disclosure the CLR application further includes control logic for accessing a raw text database stored in memory. The raw text database contains a plurality of predefined raw text vectors defining mathematical, graphical, vectorized representations of predefined raw text inputs that the host device is programmed to accept and respond to. The CLR application further includes control logic for comparing predefined raw text vectors in the raw text database to vectorized extracted syntactic information from the input.

In another aspect of the present disclosure the CLR application further includes control logic for calculating a syntactic similarity score according to a Jaccard index and a Levenshtein distance between the vectorized extracted syntactic information from the input and the plurality of predefined raw text vectors in the raw text database.

In another aspect of the present disclosure the CLR application further includes control logic for computing the output confidence score using a normalized weighted sum of the semantic similarity score and the syntactic similarity score according to:

$${C}_{out} = Z ( {w}_{i} * {Score}_{sem} + {w}_{j} * {Score}_{syn} )$$

where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . ).

In another aspect of the present disclosure the third control logic further includes control logic for assigning the output confidence score to the output. The output commands one or more actuators of the host device to adjust performance of relevant host device systems. The third control logic further causes the human validator to prioritize and review the output according to the output confidence score and a ranked context; and causes the human validator to selectively update one or more of the text vector database and the raw text database with new data obtained from the input, the output, and the output confidence score. The host device is a vehicle and output commands to the one or more actuators of the vehicle alter functionality of the vehicle in accordance with inputs received from the user.

In another aspect of the present disclosure a method for computing confidence scores for large language model (LLM) based retrieval augmentation (RAG) tools includes executing, by a processor of a controller of a vehicle, programmatic control logic stored within memory of the controller. The controller also includes input/output (I/O) ports in communication with a human-machine interface (HMI) of the vehicle. The programmatic control logic includes an algorithm for computing confidence scores for LLM based RAG tools (CLR application). The CLR application includes control logic for receiving an input to the LLM from a vehicle user via the HMI, and engaging an ensemble retriever. The ensemble retriever determines a similarity between the input and predetermined data in one or more databases stored in the memory, causes the ensemble retriever to generate an output and an output confidence score, and prioritizes and reviews the output in accordance with the output confidence score. The output is a command to one or more systems of the vehicle. The method progressively reduces computational resource utilization, progressively increases computational efficiency, and progressively reduces reliance on a human validator over time.

In another aspect of the present disclosure the method further includes engaging a semantic tool that extracts semantic information from the input. The semantic tool converts extracted semantic information from the input into a vector in vector space such that the vector defines a mathematical, graphical, vectorized representation of semantic information within the input.

In another aspect of the present disclosure the method further includes accessing a text vector database stored in memory. The text vector database contains a plurality of predefined semantic text vectors defining mathematical, graphical, vectorized representations of predefined semantic inputs that the vehicle is programmed to accept and respond to, and comparing predefined semantic text vectors in the text vector database to vectorized extracted semantic information from the input.

In another aspect of the present disclosure the method further includes using ranked fusion to calculate a semantic similarity score according to: a retrieved context Cᵢ₁, a vector similarity score, Sᵢ, and eliminating context Cᵢ when a similarity score of Cᵢ is such that the vector similarity score Sᵢ is less than a threshold T. The method further includes fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and ranking context based on the importance score ICᵢ according to:

$$Ret \_a = [ ( C\_a1 , S\_a1 ) , ( C\_a2 , S\_a2 ) , … ( {C}_{an} , {S}_{an} ) ]$$

$$Ret \_b = [ ( C\_b1 , S\_b1 ) , ( C\_b2 , S\_b2 ) , … ( {C}_{bn} , {S}_{bn} ) ]$$

$$Ret \_c = [ ( C\_c1 , S\_c1 ) , ( C\_c2 , S\_c2 ) , … ( {C}_{cn} , {S}_{cn} ) ]$$

where, context {Cᵢⱼ}, j≥1 is ranked based on similarity score, i.e.: Sᵢ₁>Sᵢ₂ . . . >Sᵢₙ. “Low quality” contexts have vector similarity scores Sᵢ less than the threshold T, while “high quality” contexts have importance scores ICᵢ indicating that the input is closely related to or directly implicates critical host device functions.

In another aspect of the present disclosure the method further includes engaging a syntactic tool that extracts syntactic information from the input. The syntactic tool converts extracted syntactic information from the input into an input raw text vector in vector space such that the vector defines a mathematical, graphical, vectorized representation of syntactic information within the input.

In another aspect of the present disclosure the method further includes accessing a raw text database stored in memory. The raw text database contains a plurality of predefined raw text vectors defining mathematical, graphical, vectorized representations of predefined raw text inputs that the vehicle is programmed to accept and respond to, and comparing predefined raw text vectors in the raw text database to vectorized extracted syntactic information from the input.

In another aspect of the present disclosure the method further includes calculating a syntactic similarity score according to a Jaccard index and a Levenshtein distance between the vectorized extracted syntactic information from the input and the plurality of predefined raw text vectors in the raw text database.

In another aspect of the present disclosure the method further includes computing the output confidence score using a normalized weighted sum of the semantic similarity score and the syntactic similarity score according to:

$${C}_{out} = Z ( {w}_{i} * {Score}_{sem} + {w}_{j} * {Score}_{syn} )$$

where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . ).

In another aspect of the present disclosure the method further includes assigning the output confidence score to the output, wherein the output commands one or more actuators of the vehicle to adjust performance of relevant vehicle systems, and prioritizing and reviewing, by the human validator, the output according to the output confidence score and a ranked context. The method further includes selectively updating, by the human validator, one or more of the text vector database and the raw text database with new data obtained from the input, the output, and the output confidence score. Output commands to the one or more actuators of the vehicle alter functionality of the vehicle in accordance with inputs received from the user.

In another aspect of the present disclosure the method further includes a method for computing confidence scores for large language model (LLM) based retrieval augmentation (RAG) tools. The method includes executing, by a processor of a controller of a vehicle, programmatic control logic stored within memory of the controller, the controller further having input/output (I/O) ports in communication with a human-machine interface (HMI) of the vehicle, the programmatic control logic including an algorithm for computing confidence scores for LLM based RAG tools (CLR application). The CLR application includes control logic for: receiving an input to the LLM from a vehicle user via the HMI, and engaging an ensemble retriever. The ensemble retriever that determines a similarity between the input and predetermined data in one or more databases stored in the memory. The CLR application further includes control logic for causing the ensemble retriever to generate an output and an output confidence score, and for prioritizing and reviewing the output in accordance with the output confidence score. The output is a command to one or more systems of the vehicle, and the method progressively reduces computational resource utilization, progressively increases computational efficiency, and progressively reduces reliance on a human validator over time. The CLR application further includes control logic for engaging a semantic tool that extracts semantic information from the input. The semantic tool converts extracted semantic information from the input into a vector in vector space such that the vector defines a mathematical, graphical, vectorized representation of semantic information within the input. The CLR application further includes control logic for accessing a text vector database stored in memory. The text vector database contains a plurality of predefined semantic text vectors defining mathematical, graphical, vectorized representations of predefined semantic inputs that the vehicle is programmed to accept and respond to. The CLR application further includes control logic for comparing predefined semantic text vectors in the text vector database to vectorized extracted semantic information from the input, and for using ranked fusion to calculate a semantic similarity score according to: a retrieved context Cᵢ₁, a vector similarity score, Sᵢ, and eliminating context Cᵢ when a similarity score of Cᵢ is such that the vector similarity score Sᵢ is less than a threshold T. The CLR application further includes control logic for fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and ranking context based on the importance score ICᵢ according to:

$$Ret \_a = [ ( C\_a1 , S\_a1 ) , ( C\_a2 , S\_a2 ) , … ( {C}_{an} , {S}_{an} ) ]$$

$$Ret \_b = [ ( C\_b1 , S\_b1 ) , ( C\_b2 , S\_b2 ) , … ( {C}_{bn} , {S}_{bn} ) ]$$

$$Ret \_c = [ ( C\_c1 , S\_c1 ) , ( C\_c2 , S\_c2 ) , … ( {C}_{cn} , {S}_{cn} ) ]$$

where, context {Cᵢⱼ}, j≥1 is ranked based on similarity score, i.e.: Sᵢ₁>Sᵢ₂ . . . >Sᵢₙ. The CLR application further includes control logic for engaging a syntactic tool that extracts syntactic information from the input. The syntactic tool converts extracted syntactic information from the input into an input raw text vector in vector space such that the vector defines a mathematical, graphical, vectorized representation of syntactic information within the input. The CLR application further includes control logic for accessing a raw text database stored in memory, where the raw text database contains a plurality of predefined raw text vectors defining mathematical, graphical, vectorized representations of predefined raw text inputs that the vehicle is programmed to accept and respond to. The CLR application further includes control logic for comparing predefined raw text vectors in the raw text database to vectorized extracted syntactic information from the input, and for calculating a syntactic similarity score according to a Jaccard index and a Levenshtein distance between the vectorized extracted syntactic information from the input and the plurality of predefined raw text vectors in the raw text database. The CLR application further includes control logic for computing the output confidence score using a normalized weighted sum of the semantic similarity score and the syntactic similarity score according to:

$${C}_{out} = Z ( {w}_{i} * {Score}_{sem} + {w}_{j} * {Score}_{syn} )$$

where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . ). The CLR application further includes control logic for assigning the output confidence score to the output, wherein the output commands one or more actuators of the vehicle to adjust performance of relevant vehicle systems, and for prioritizing and reviewing, by the human validator, the output according to the output confidence score and a ranked context. The CLR application further includes control logic for selectively updating, by the human validator, one or more of the text vector database and the raw text database with new data obtained from the input, the output, and the output confidence score. Output commands to the one or more actuators of the vehicle alter functionality of the vehicle in accordance with inputs received from the user.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram depicting a system for computing confidence scores for large language model (LLM) based retrieval augmentation (RAG) tools according to an exemplary embodiment; and

FIG. 2 is a flowchart depicting logical flow of an application of the system for computing confidence scores for LLM based RAG tools of FIG. 1 according to an exemplary embodiment.

### DETAILED DESCRIPTION

The following description is merely exemplary in nature and is not intended to limit the present disclosure, application, or uses.

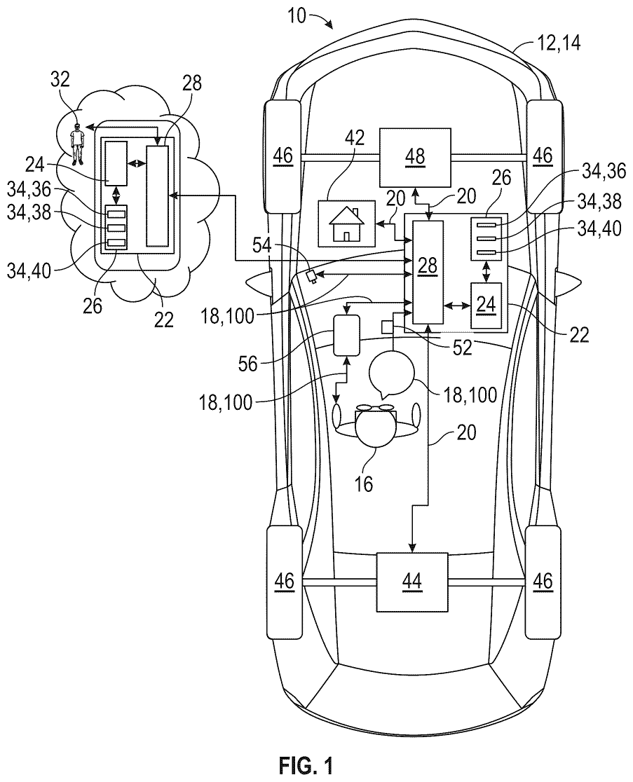

Referring to FIG. 1, a system 10 for computing confidence scores for large language model (LLM) based retrieval augmentation (RAG) tools is shown in schematic form. The system 10 generally functions in or on a host device 12. The host device 12 may take any of a wide variety of forms, including a vehicle 14. However, it should be appreciated that the system 10 of the present disclosure need not be tied to such a vehicle 14. Rather, the vehicle 14 is merely an exemplary non-limiting embodiment in relation to which the system 10 of the present disclosure is described herein. The system 10 may operate in any hardware and software configuration in which a generative AI powered tool is used to receive inputs from a user 16, such as user commands 18, and generate an output 20 that alters the function of the hardware and/or software configuration or system in which the generative AI powered tool is being used. Additionally, while the vehicle 14 shown is a car, it should be appreciated that the vehicle 14 may be any type of vehicle 14 without departing from the scope or intent of the present disclosure. In several non-limiting examples, the vehicle 14 may be a: car, truck, sport utility vehicle (SUV), semi truck, tractor trailer, tractor, combine harvester or other such farming equipment, powered flight and unpowered aircraft such as a plane, helicopter, glider or autogyro, powered and unpowered watercraft such as: a ship, sailboat, motorboat, pleasurecraft, jet ski, sailboat, or the like. In additional non-limiting embodiments, it should be appreciated that the system 10 described herein may be adapted to function with host devices 12 such as manned and unmanned spacecraft such as: satellites, rockets, space stations, and other orbital and extra-orbital satellite-communications-enabled devices without departing from the scope or intent of the present disclosure. In still further non-limiting examples, the host devices 12 may include mobile computing platforms such as laptops, mobile phones, tablets, or any other such host device 12 through which a user may engage with a generative AI powered tool.

The system 10 further includes a controller 22 which is a non-generalized, electronic control device having a preprogrammed digital computer or processor 24, non-transitory computer readable medium or memory 26 used to store data such as control logic, software applications, instructions, computer code, data, lookup tables, etc., and a transceiver or input/output (I/O) ports 28. Computer readable medium or memory 26 includes any type of medium capable of being accessed by a computer, such as read only memory (ROM), random access memory (RAM), a hard disk drive, a compact disc (CD), a digital video disc (DVD), or any other type of memory 26. A “non-transitory” computer readable memory 26 excludes wired, wireless, optical, or other communication links that transport transitory electrical or other signals. A non-transitory computer readable memory 26 includes media where data can be permanently stored and media where data can be stored and later overwritten, such as a rewritable optical disc or an erasable memory device. Computer code includes any type of program code, including source code, object code, and executable code. The processor 24 is configured to execute the code or instructions.

Where the system 10 operates on a vehicle 14, the controller 22 may include a dedicated Wi-Fi controller or an engine control module, a transmission control module, a body control module, an infotainment control module, etc. The transceiver or I/O ports 28 are configured to wirelessly communicate with a back office 30 using cellular protocols including global system for mobile communication (GSM), general packet radio service (GPRS), enhanced data rates for GSM evolution (EDGE), universal mobile telecommunications services (UMTS), high speed packet access (HSPA), code-division multiple access (CDMA), evolution-data optimized (EV-DO/EVDO/1×EV-DO), short message services (SMS), Wi-MAX, manufacturing messages specification (MMS), 2G, 3G, 4G, 5G, wireless and cellular standards as defined under IEEE 802.1X, IEEE 802 LAN/MAN, and IEEE mobile communication networks standards committee (MobiNet-SC) standards, and the like. The back office 30 may include one or more controllers 22 and/or one or more human experts or validators 32 shown and described in additional detail in subsequent figures.

The controller 22 further includes one or more applications 34. An application 34 is a software program configured to perform a specific function or set of functions. The application 34 may include one or more computer programs, software components, sets of instructions, procedures, functions, objects, classes, instances, related data, or a portion thereof adapted for implementation in a suitable computer readable program code. The applications 34 may be stored within the memory 26 or in additional or separate memory. Examples of the applications 34 include audio or video streaming services, games, browsers, social media, etc., and an algorithm that computes confidence scores for large language model (LLM) 36 based RAG tools 38 (hereinafter CLR application 40) for a generative AI powered tool or LLM 36 tool. The generative AI powered tool or LLM 36 defines an application 34 stored either locally on the vehicle 14 controller 22 and/or in a remote back office 30 or cloud-based computing device. The CLR application 40 includes a plurality of subroutines or control logic portions.

In examples in which the system 10 operates in or on a vehicle 14, the system 10 and CLR application 40 may be used by the vehicle operator or a vehicle development engineering user 16 to validate the tools used to develop and test systems that dynamically adjust the way that the vehicle 14 and vehicle 14 features are operated. In some examples, the vehicle 14 may be equipped with a navigation system 42, one or more drive motors 44 that provide and alter quantities of torque delivered to wheels 46 of the vehicle 14 to cause the vehicle 14 to move, stop, or the like, and a steering system 48 that may adjust a directional heading of the vehicle 14. In additional examples, the vehicle 14 is equipped with a braking system 50 that, when engaged by the controller 22 causes the motion of the vehicle 14 to be retarded. The vehicle 14 may be equipped with a variety of other body motion control systems that may be engaged to alter, or otherwise control dynamic performance of the vehicle 14, including but not limited to aerodynamic control surfaces and actuators, active and/or semi-active suspension systems and actuators, and the like without departing from the scope or intent of the present disclosure.

LLMs 36 are trained on vast quantities of data in one or more of online and offline modes. The training data provides a way for the LLMs 36 to effectively generate outputs for tasks such as answering questions, performing mathematical calculations, performing language translation and/or summarization. Retrieval augmented generation (RAG) is an architectural approach for improving quality of LLM 36 generated responses by grounding the LLM 36 model on external sources of knowledge to supplement the LLM's 36 internal representation of information. Implementing RAG in an LLM 36 based question answering system has at least two main benefits: ensuring that the LLM 36 has access to the most current, reliable, relevant data with a defined scope, and that users 16 have access to the LLM's 36 sources, ensuring that the LLM's 36 responses to user 16 inputs may be appropriate and trusted. Additionally, RAG grounds the LLM 36 on a set of external, verifiable facts, resulting in an LLM 36 that has few opportunities to pull information baked into its parameters, thereby reducing the chances that the LLM 36 will leak sensitive data or provide incorrect or misleading responses to user 16 inputs. More specifically, the LLM 36 based RAG tools 38 of the present disclosure extend the capabilities of and improves the efficiency of LLM 36 applications by leveraging customized data. The customized data may relate to any of a wide range of topics, but should generally be understood to relate specifically to particular hardware or software applications of the host device 12. In a non-limiting example, the customized or domain-specific knowledge data may relate to onboard systems of a vehicle 14, including but not limited to navigation systems, powertrain control systems, suspension control systems, heating ventilation and air conditioning (HVAC) systems, and the like. The LLMs 36 utilize RAG tool 38 customized data relevant to a user 16 generated command, question or task and provide the customized data as context for the LLM 36 to generate a response. In many respects, RAG is an effective approach to improve LLM 36 performance and is successful in supporting chatbots and question and answer (Q&A) systems that require access to domain-specific information. Domain-specific information may include any of a wide range of data relating to the particular host device 12, vehicle 14, and back office 30 functions, and relating additionally to the onboard hardware, software, and applications for each of the host device 12, vehicle 14, and back office 30. Domain-specific information may also relate to specific proprietary data held by an original equipment manufacturer (OEM), relating to the specific hardware and software products manufactured by the OEM. The domain-specific information may define an embedded model stored within memory 26 of the controller 22 onboard the host device 12.

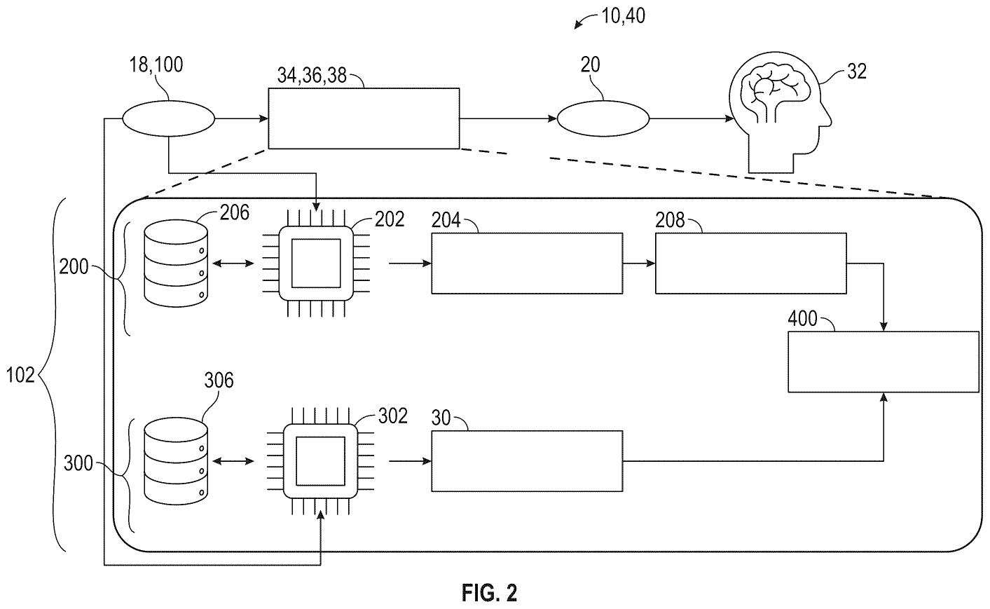

Referring now to FIG. 2 and with continuing reference to FIG. 1, an exemplary schematic logical flow diagram of the CLR application 40 is shown in additional detail. The CLR application 40 receives an input 100 in an offline mode. The input 100 may be received via a host device 12 human-machine interface (HMI), including but not limited to an audio or visual or audiovisual receiver such as a microphone or other audio sensor 52, a camera or other vision sensor 54, tactile interfaces including but not limited to buttons and touchscreens 56, or the like. In several examples, the input 100 is a user 16 command 18, which is subsequently processed through the LLM 36 based RAG tool 38 in a series of subroutines before generating the output 20. The input 100 may take any of a wide variety of forms without departing from the scope or intent of the present disclosure. In some non-limiting examples, the input 100 may include verbal or written user commands 18 in any language, such as: commands to engage the vehicle 14 navigation system, commands to search for a point of interest, commands to change a vehicle 14 cabin temperature, commands to pause or wait or delay, requests to obtain a solution to a mathematical statement, or any other such commands 18. The input 100 is processed through a plurality of subroutines within the LLM 36 based RAG tool 38.

The output 20 is a host device 12 response to the input 100 from the user 16. In several aspects, the output 20 directly or indirectly alters the function of one or more systems of the host device 12, including but not limited to: altering one or more functions of the navigation system, powertrain control system, suspension control system, HVAC system, or the like. The output 20, may thus include changing a navigation system destination or route planning functionality, changing a powertrain, suspension control, or HVAC system mode or operation by directly or indirectly altering positions of actuators of the host device within relevant host device 12 systems to adjust the performance of the relevant system in response to the user 16 command 18 input 100.

The RAG tool 38 includes an ensemble retriever 102. Ensemble retrievers 102 are sophisticated retrieval algorithms that improve relevancy of retrieved context information by pooling results from multiple distinct and parallel retrievers. Through the use of multiple parallel retrievers, strengths of each of the multiple parallel retrievers may be leveraged to more accurately fetch results relating to the user command 18 or input 100 than individual data retriever algorithms might individually. The input 100 is received within the ensemble retriever 102 by at least two parallel subroutines of the LLM 36 based RAG tool 38, namely a semantic tool 200 and a syntactic tool 300. The semantic tool 200 receives the input 100 in a semantic retriever 202. The semantic retriever 202 subroutine first extracts semantic information from the input 100. The semantic retriever 202 then calculates a semantic similarity score 204 for the semantic information extracted from the input 100. To calculate the semantic similarity score 204, the semantic retriever 202 converts the extracted semantic information from the input 100 into a semantic text vector in vector space such that the vector is a mathematical, graphical representation of the extracted semantic information from the input 100. In a non-limiting example, the input 100 may include a verbal command from a user 16. It should be appreciated that the verbal command may be any of a wide variety of different commands, including but not limited to: “increase cabin temperature”, with the user 16 intending that the input 100 command cause the vehicle 14 to utilize a heating, ventilation and air-conditioning (HVAC) system to alter a temperature of the vehicle 14 passenger compartment. Each word, i.e. “increase,” “cabin”, and “temperature”, in the user 16 input 100 command is parsed and plotted in vector space and subsequently compared to predetermined text vectors in a text vector database 206 stored in memory 26.

Because individual user 16 language input 100 commands may differ in actual diction or verbiage chosen, the vector representing the input 100 may not be precisely represented by text vectors stored in the text vector database 206. The text vector database 206 contains a plurality of semantic text vectors defining mathematical, graphical, vectorized representations of predefined semantic inputs 100 that the host device 12 is programmed to accept, respond to, and understand. The plurality of text vectors in the text vector database 206 may be manually and/or automatically chosen during pre-production programming of the system 10, and the plurality of text vectors may be updated with new information upon the occurrence of a particular event, or may be updated or modified manually or automatically, constantly, periodically, or the like. In non-limiting examples, the text vector database 206 is updated by the human experts or validators 32.

Accordingly, the semantic retriever 202 calculates the semantic similarity score 204 based on the text vector representing the input 100 and predefined text vector information accessed within the text vector database 206. In several aspects, the semantic similarity score 204 is a numerical, graphical, vectorized representation of a level of similarity between the semantic structure of the input 100 and the semantic structure of the of the text vectors corresponding most closely to the semantic text vector of the input 100. After calculating the semantic similarity score 204, the semantic tool 200 performs a rank fusion calculation 208 that filters the input 100 context based on a threshold T to avoid “low quality” contexts or low-quality matches between the data in the text vector database 206 and the text vector representing the input data 100. More specifically, the CLR application 40 utilizes a reciprocal rank fusion algorithm to re-rank and merge results from each of the semantic tool 200 and syntactic tool 300.

That is, the ensemble retriever 102 (Retᵢ) obtains a retrieved context Cᵢ₁, and vector similarity score, Sᵢ₁, and eliminates context Cᵢ if and only if the similarity score of Cᵢ is such that the vector similarity score Sᵢ is less than the threshold T. By contrast, “high quality” contexts are defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ). The contexts are then ranked based on the importance score ICᵢ. Thus, in some non-limiting examples, a series of ranked semantic similarity scores are generated according to:

$${Ret}_{a} = [ ( {C}_{a 1} , {S}_{a 1} ) , ( {C}_{a 2} , {S}_{a 2} ) , … ( {C}_{an} , {S}_{an} ) ]$$

$${Ret}_{b} = [ ( {C}_{b 1} , {S}_{b 1} ) , ( {C}_{b 2} , {S}_{b 2} ) , … ( {C}_{an} , {S}_{an} ) ]$$

$${Ret}_{c} = [ ( {C}_{c 1} , {S}_{c 1} ) , ( {C}_{c 2} , {S}_{c 2} ) , … ( {C}_{an} , {S}_{an} ) ]$$

where, context {Cᵢⱼ}, j≥1 is ranked based on similarity score, i.e.: Sᵢ₁>Sᵢ₂ . . . >Sᵢₙ. The importance score ICᵢ defines a relative importance of the context Cᵢ in relation to the type of input 100 received. Thus, in a non-limiting example, the importance score ICᵢ has a low value for contexts Cᵢ, such as HVAC functions, that do not implicate critical host device 12 functions, such as powertrain, suspension or safety critical systems of a vehicle 14. By contrast, the importance score ICᵢ is higher than the low value when the context Cᵢ indicates that the input 100 is more closely related to or directly implicates critical host device 12 functions.

By contrast, the syntactic tool 300, which operates in parallel with the semantic tool 200, receives the input 100 within a syntactic retriever 302. The syntactic retriever 302 subroutine, like the semantic retriever 202 subroutine, first extracts syntactic information from the input 100. The syntactic retriever 302 subroutine then calculates a syntactic similarity score 304 based on the raw text of the input 100 and a raw text database 306 stored in memory 26. The raw text database 306 contains a plurality of plurality of raw text vectors defining mathematical, graphical, vectorized representations of predefined syntactic inputs 100 that the host device 12 is programmed to accept and understand. The plurality of raw text vectors in the raw text database 306 may be manually and/or automatically chosen during pre-production programming of the system 10, and the plurality of raw text vectors may be updated with new information upon the occurrence of a particular event, or may be updated or modified manually or automatically, constantly, periodically, or the like. In non-limiting examples, the raw text database 306 is updated by the human experts or validators 32.

To calculate the syntactic similarity score 304, the syntactic retriever 302 subroutine converts the extracted syntactic information from the input 100 into a raw text vector in vector space such that the vector is a mathematical, graphical representation of the extracted syntactic information from the input 100. The syntactic similarity score 304 is a numerical representation of a level of similarity between the syntactic structure of the input 100 and data in the raw text database 36. More specifically, the syntactic similarity score 304 is calculated on the basis of a Jaccard index and a Levenshtein distance between. The Jaccard index,

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} ,$$

is used to gauge the similarity and diversity of the input 100 information to predefined raw text information stored in the raw text database 306. Similarly, the Levenshtein distance is a string metric used to measure a difference between two sequences, or in the present instance, a difference between the raw text of the input 100 and the raw text stored in the raw text database 306. In an example, a Levenshtein distance between two words is the minimum number of single-character edits (i.e. insertions, deletions, or substitutions) required to change one word into the other. The Levenshtein distance may be mathematically represented as follows:

$$lev ( a , b ) = \{ \begin{matrix}\vert a \vert & if \vert b \vert = 0 , \\ \vert b \vert & if \vert a \vert = 0 , \\ lev ( tail ( a ) , tail ( b ) & if head ( a ) = head ( b ) , \\ 1 + min \{ \begin{matrix}lev ( tail ( a ) , b ) \\ lev ( a , tail ( b ) ) \\ lev ( tail ( a ) , tail ( b )\end{matrix} & otherwise .\end{matrix}$$

It should be appreciated that use of the Jaccard index and Levenshtein distance are intended only as exemplary non-limiting examples of the types of algorithms or functions that may be used to compute a syntactic similarity score 304 according to the object of the present disclosure. The semantic and syntactic similarity scores 204, 304 may cover ranges of values that vary from application to application, but in one non-limiting example, the semantic and syntactic similarity scores 204, 304 are variable between values of zero (0) and one (1), such that when there is no similarity at all, the semantic and/or syntactic similarity scores 204, 304 is/are equal to zero, and when there is perfect identity between the semantic and/or syntactic similarity scores 204, 304 and information in the text vector database 206 or the raw text database 306, the values of the semantic and/or syntactic similarity scores is/are equal to one.

Subsequently, outputs of the ranked fusion calculation 208 and the syntactic similarity score 304 are combined and a confidence score 400 is calculated. The confidence score 400 is a normalized, weighted sum of the semantic similarity scores 204 and the syntactic similarity scores 304. The confidence score may be represented as:

$${C}_{out} = Z ( {w}_{i} * {Score}_{sem} + {w}_{j} * {Score}_{syn} )$$

where Z ( . . . ) is the normalization function, and Wᵢ, Wⱼ are the weights. The semantic similarity score 204 is: Scoreₛₑₘ=f(rank fusion score), and the syntactic similarity score 304 is: Score_{syn}=f(Jaccard Index, Levenshtein Distance, . . . ).

In several aspects, the weights Wᵢ, Wⱼ may vary substantially from application to application. The weights Wᵢ, Wⱼ may be chosen by an application developer, an original equipment manufacturer, a supplier, or the like. It should further be appreciated that the weights Wᵢ, Wⱼ may be dynamic, variable, or constant, depending on the types of queries and the structures of the queries that the system 10 receives as inputs 100.

As described herein, LLM 36 based RAG tools 38 generate outputs 20 that, at least in pre-production processes, require verification and validation by human experts or validators 32. However, the system 10 of the present disclosure offers several advantages, including but not limited to, the automatic generation, via the CLR application 40 of the present disclosure, of a confidence score for outputs 20 of the LLM 36 such that the human experts or validators 32 may efficiently prioritize verification, thereby substantially reducing quantities of human effort and man-hours necessary to verify outputs 20 of the LLM 36, while increasing LLM 36 accuracy, reducing computational effort and computational resource consumption, and reducing the potential for human-introduced typographical, syntactical, or other such errors from a first quantity to a second quantity substantially less than the first quantity. In an example, the experts or validators 32 may choose to verify LLM 36 outputs 20 having low confidence values first, and subsequently acting to verify LLM 36 outputs 20 with confidence levels higher than the low confidence values. Accordingly, by leveraging vector-based similarity scores of a retriever and the input 100 similarity score (e.g. Jaccard distance) of a given input 100, confidence scores may be automatically computed. It will further be appreciated that in either pre-production or production guises, as the CLR 40 is continuously utilized, evaluated, and updated over time, a quantity of human expert or validator 26 interaction and input is decreased. That is, even in a production application in which a non-engineer end user or customer interacts with the LLM 36, the CLR application 40 operates to accurately, consistently, reliably, and robustly interpret end user or customer inputs to the system 10 and to generate a response accordingly, with progressively reduced computational resource utilization, progressively increased computational efficiency, and progressively reduced reliance on human validator 26 verifications.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for computing confidence scores for large language model (LLM) based retrieval augmentation (RAG) tools, the system comprising:
a host device having a controller, the controller having a processor, a memory, and input/output (I/O) ports, the I/O ports in communication with a human-machine interface (HMI) and one or more databases, the processor executing programmatic control logic stored in the memory, the programmatic control logic including an algorithm for computing confidence scores for LLM based RAG tools (CLR application), the CLR application comprising:
a first control logic that receives an input to the LLM from a host device user;
a second control logic that engages an ensemble retriever, wherein the ensemble retriever that determines a similarity between the input and predetermined data in the one or more databases stored in the memory;
a third control logic that causes the ensemble retriever to generate an output and an output confidence score; and
a fourth control logic that causes a human validator to prioritize and review the output in accordance with the output confidence score, wherein the output is a command to one or more systems of the host device, and wherein the system progressively reduces computational resource utilization, progressively increases computational efficiency, and progressively reduces reliance on the human validator over time.

2. The system of claim 1 wherein the first control logic further comprises:
control logic for receiving the input via the human-machine interface (HMI) of the host device.

3. The system of claim 1 wherein the second control logic further comprises:
engaging a semantic tool that extracts semantic information from the input; and
wherein the semantic tool converts extracted semantic information from the input into a vector in vector space such that the vector defines a mathematical, graphical, vectorized representation of semantic information within the input.

4. The system of claim 3, wherein the semantic tool further comprises:
control logic for accessing a text vector database stored in memory, wherein the text vector database contains a plurality of predefined semantic text vectors defining mathematical, graphical, vectorized representations of predefined semantic inputs that the host device is programmed to accept and respond to; and
control logic for comparing predefined semantic text vectors in the text vector database to vectorized extracted semantic information from the input.

5. The system of claim 4, wherein the semantic tool further comprises:
control logic for using ranked fusion to calculate a semantic similarity score according to:
a retrieved context Cᵢ₁, a vector similarity score, Sᵢ, and eliminating context Cᵢ when a similarity score of Cᵢ is such that the vector similarity score Sᵢ is less than a threshold T;
fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and
ranking context based on the importance score ICᵢ according to:
$$Ret \_a = [ ( C\_a1 , S\_a1 ) , ( C\_a2 , S\_a2 ) , … ( {C}_{an} , {S}_{an} ) ]$$
$$Ret \_b = [ ( C\_b1 , S\_b1 ) , ( C\_b2 , S\_b2 ) , … ( {C}_{bn} , {S}_{bn} ) ]$$
$$Ret \_c = [ ( C\_c1 , S\_c1 ) , ( C\_c2 , S\_c2 ) , … ( {C}_{cn} , {S}_{cn} ) ]$$
where, context {Cᵢⱼ}, j≥1 is ranked based on similarity score, i.e.: Sᵢ₁>Sᵢ₂ . . . >Sᵢₙ, wherein “low quality” contexts have vector similarity scores Sᵢ less than the threshold T, while “high quality” contexts have importance scores ICᵢ indicating that the input is closely related to or directly implicates critical host device functions.

6. The system of claim 5, further comprising:
engaging a syntactic tool that extracts syntactic information from the input; and
wherein the syntactic tool converts extracted syntactic information from the input into an input raw text vector in vector space such that the vector defines a mathematical, graphical, vectorized representation of syntactic information within the input.

7. The system of claim 6, further comprising:
control logic for accessing a raw text database stored in memory, wherein the raw text database contains a plurality of predefined raw text vectors defining mathematical, graphical, vectorized representations of predefined raw text inputs that the host device is programmed to accept and respond to; and
control logic for comparing predefined raw text vectors in the raw text database to vectorized extracted syntactic information from the input.

8. The system of claim 7, further comprising:
control logic for calculating a syntactic similarity score according to a Jaccard index and a Levenshtein distance between the vectorized extracted syntactic information from the input and the plurality of predefined raw text vectors in the raw text database.

9. The system of claim 8 further comprising:
control logic for computing the output confidence score using a normalized weighted sum of the semantic similarity score and the syntactic similarity score according to:
$${C}_{out} = Z ( {w}_{i} * {Score}_{sem} + {w}_{j} * {Score}_{syn} )$$
where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . ).

10. The system of claim 9, wherein the third control logic further comprises:
control logic for assigning the output confidence score to the output, wherein the output commands one or more actuators of the host device to adjust performance of relevant host device systems;
control logic that causes the human validator to prioritize and review the output according to the output confidence score and a ranked context; and
causing the human validator to selectively update one or more of the text vector database and the raw text database with new data obtained from the input, the output, and the output confidence score, and
wherein the host device comprises a vehicle and output commands to the one or more actuators of the vehicle alter functionality of the vehicle in accordance with inputs received from the user.

11. A method for computing confidence scores for large language model (LLM) based retrieval augmentation (RAG) tools, the method comprising:
executing, by a processor of a controller of a vehicle, programmatic control logic stored within memory of the controller, the controller further having input/output (I/O) ports in communication with a human-machine interface (HMI) of the vehicle, the programmatic control logic including an algorithm for computing confidence scores for LLM based RAG tools (CLR application), the CLR application comprising control logic for:
receiving an input to the LLM from a vehicle user via the HMI;
engaging an ensemble retriever, wherein the ensemble retriever that determines a similarity between the input and predetermined data in one or more databases stored in the memory;
causing the ensemble retriever to generate an output and an output confidence score; and
prioritizing and reviewing the output in accordance with the output confidence score, wherein the output is a command to one or more systems of the vehicle, and wherein the method progressively reduces computational resource utilization, progressively increases computational efficiency, and progressively reduces reliance on a human validator over time.

12. The method of claim 11 further comprising:
engaging a semantic tool that extracts semantic information from the input; and
wherein the semantic tool converts extracted semantic information from the input into a vector in vector space such that the vector defines a mathematical, graphical, vectorized representation of semantic information within the input.

13. The method of claim 12, further comprising:
accessing a text vector database stored in memory, wherein the text vector database contains a plurality of predefined semantic text vectors defining mathematical, graphical, vectorized representations of predefined semantic inputs that the vehicle is programmed to accept and respond to; and
comparing predefined semantic text vectors in the text vector database to vectorized extracted semantic information from the input.

14. The method of claim 13, further comprising:
using ranked fusion to calculate a semantic similarity score according to:
a retrieved context Cᵢ₁, a vector similarity score, Sᵢ, and eliminating context Cᵢ when a similarity score of Cᵢ is such that the vector similarity score Sᵢ is less than a threshold T;
fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and
ranking context based on the importance score ICᵢ according to:
$$Ret \_a = [ ( C\_a1 , S\_a1 ) , ( C\_a2 , S\_a2 ) , … ( {C}_{an} , {S}_{an} ) ]$$
$$Ret \_b = [ ( C\_b1 , S\_b1 ) , ( C\_b2 , S\_b2 ) , … ( {C}_{bn} , {S}_{bn} ) ]$$
$$Ret \_c = [ ( C\_c1 , S\_c1 ) , ( C\_c2 , S\_c2 ) , … ( {C}_{cn} , {S}_{cn} ) ]$$
where, context {Cᵢⱼ}, j≥1 is ranked based on similarity score, i.e.: Sᵢ₁>Sᵢ₂ . . . >Sᵢₙ, wherein “low quality” contexts have vector similarity scores Sᵢ less than the threshold T, while “high quality” contexts have importance scores ICᵢ indicating that the input is closely related to or directly implicates critical host device functions.

15. The method of claim 14, further comprising:
engaging a syntactic tool that extracts syntactic information from the input; and
wherein the syntactic tool converts extracted syntactic information from the input into an input raw text vector in vector space such that the vector defines a mathematical, graphical, vectorized representation of syntactic information within the input.

16. The method of claim 15, further comprising:
accessing a raw text database stored in memory, wherein the raw text database contains a plurality of predefined raw text vectors defining mathematical, graphical, vectorized representations of predefined raw text inputs that the vehicle is programmed to accept and respond to; and
comparing predefined raw text vectors in the raw text database to vectorized extracted syntactic information from the input.

17. The method of claim 16, further comprising:
calculating a syntactic similarity score according to a Jaccard index and a Levenshtein distance between the vectorized extracted syntactic information from the input and the plurality of predefined raw text vectors in the raw text database.

18. The method of claim 17 further comprising:
computing the output confidence score using a normalized weighted sum of the semantic similarity score and the syntactic similarity score according to:
$${C}_{out} = Z ( {w}_{i} * {Score}_{sem} + {w}_{j} * {Score}_{syn} )$$
where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . ).

19. The method of claim 18, further comprising:
assigning the output confidence score to the output, wherein the output commands one or more actuators of the vehicle to adjust performance of relevant vehicle systems; and
prioritizing and reviewing, by the human validator, the output according to the output confidence score and a ranked context; and
selectively updating, by the human validator, one or more of the text vector database and the raw text database with new data obtained from the input, the output, and the output confidence score, and
wherein output commands to the one or more actuators of the vehicle alter functionality of the vehicle in accordance with inputs received from the user.

20. A method for computing confidence scores for large language model (LLM) based retrieval augmentation (RAG) tools, the method comprising:
executing, by a processor of a controller of a vehicle, programmatic control logic stored within memory of the controller, the controller further having input/output (I/O) ports in communication with a human-machine interface (HMI) of the vehicle, the programmatic control logic including an algorithm for computing confidence scores for LLM based RAG tools (CLR application), the CLR application comprising control logic for:
receiving an input to the LLM from a vehicle user via the HMI;
engaging an ensemble retriever, wherein the ensemble retriever that determines a similarity between the input and predetermined data in one or more databases stored in the memory;
causing the ensemble retriever to generate an output and an output confidence score;
prioritizing and reviewing the output in accordance with the output confidence score, wherein the output is a command to one or more systems of the vehicle, and wherein the method progressively reduces computational resource utilization, progressively increases computational efficiency, and progressively reduces reliance on a human validator over time;
engaging a semantic tool that extracts semantic information from the input; and
wherein the semantic tool converts extracted semantic information from the input into a vector in vector space such that the vector defines a mathematical, graphical, vectorized representation of semantic information within the input;
accessing a text vector database stored in memory, wherein the text vector database contains a plurality of predefined semantic text vectors defining mathematical, graphical, vectorized representations of predefined semantic inputs that the vehicle is programmed to accept and respond to; and
comparing predefined semantic text vectors in the text vector database to vectorized extracted semantic information from the input;
using ranked fusion to calculate a semantic similarity score according to:
a retrieved context Cᵢ₁, a vector similarity score, Sᵢ, and eliminating context Cᵢ when a similarity score of Cᵢ is such that the vector similarity score Sᵢ is less than a threshold T;
fusing “high quality” contexts defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ); and
ranking context based on the importance score ICᵢ according to:
$$Ret \_a = [ ( C\_a1 , S\_a1 ) , ( C\_a2 , S\_a2 ) , … ( {C}_{an} , {S}_{an} ) ]$$
$$Ret \_b = [ ( C\_b1 , S\_b1 ) , ( C\_b2 , S\_b2 ) , … ( {C}_{bn} , {S}_{bn} ) ]$$
$$Ret \_c = [ ( C\_c1 , S\_c1 ) , ( C\_c2 , S\_c2 ) , … ( {C}_{cn} , {S}_{cn} ) ]$$
where, context {Cᵢⱼ}, j≥1 is ranked based on similarity score, i.e.: Sᵢ₁>Sᵢ₂ . . . >Sᵢₙ, wherein “low quality” contexts have vector similarity scores Sᵢ less than the threshold T, while “high quality” contexts have importance scores ICᵢ indicating that the input is closely related to or directly implicates critical host device functions;
engaging a syntactic tool that extracts syntactic information from the input; and
wherein the syntactic tool converts extracted syntactic information from the input into an input raw text vector in vector space such that the vector defines a mathematical, graphical, vectorized representation of syntactic information within the input;
accessing a raw text database stored in memory, wherein the raw text database contains a plurality of predefined raw text vectors defining mathematical, graphical, vectorized representations of predefined raw text inputs that the vehicle is programmed to accept and respond to; and
comparing predefined raw text vectors in the raw text database to vectorized extracted syntactic information from the input;
calculating a syntactic similarity score according to a Jaccard index and a Levenshtein distance between the vectorized extracted syntactic information from the input and the plurality of predefined raw text vectors in the raw text database;
computing the output confidence score using a normalized weighted sum of the semantic similarity score and the syntactic similarity score according to:
$${C}_{out} = Z ( {w}_{i} * {Score}_{sem} + {w}_{j} * {Score}_{syn} )$$
where Z ( . . . ) is a normalization function, and Wᵢ, Wⱼ are weights, the semantic similarity score is: Scoreₛₑₘ=f(rank fusion score), and the syntactic similarity score is: Score_{syn}=f(Jaccard Index, Levenshtein Distance, . . . );
assigning the output confidence score to the output, wherein the output commands one or more actuators of the vehicle to adjust performance of relevant vehicle systems; and
prioritizing and reviewing, by the human validator, the output according to the output confidence score and a ranked context; and
selectively updating, by the human validator, one or more of the text vector database and the raw text database with new data obtained from the input, the output, and the output confidence score, and
wherein output commands to the one or more actuators of the vehicle alter functionality of the vehicle in accordance with inputs received from the user.
